(19) United States
(12) Patent Application Publication
(10) Pub. No.: US 2018/0361563 A1
(43) Pub. Date: Dec. 20, 2018

(54) THE TOOL BOX WIDGET

(71) Applicant: Jonathan Hurley, Seattle, WA (US)

(72) Inventor: Jonathan Hurley, Seattle, WA (US)

(21) Appl. No.: 15/622,169

(22) Filed: Jun. 14, 2017

(51) Int. Cl. B25H 3/02; B25H 3/00; H01F 7/02

(52) U.S. Cl. CPC B25H 3/022; H01F 7/0252; B25H 3/003

(57) ABSTRACT

The Tool Box Widget is the only product of its kind to come with modular pieces, granting flexibility in how the set is positioned. The Tool Box Widget is uniquely designed to be magnetic, making the organizational design impermanent and customizable at all times.

### BACKGROUND OF THE INVENTION

### Field of the Invention

The present invention is a hardware accessory. More specifically, the present invention is a custom tool storage hardware.

### Description of the Related Art

There are currently no feasible products on the market that offer an accessory that can provide custom organization for tool storages. Most individuals keep their mechanical instruments stored within boxes or varied containers; however, these storage bins tend to hold many devices. Having so many instruments within a box can make it difficult to find the one needed for use due to clutter.

### SUMMARY OF THE INVENTION

The present invention is a custom organization accessory for tool storages.

The custom tool accessory includes a tongue, grooves, a magnet and a widget.

It is an object of the present invention to provide ten widgets in a set that come in various shapes and sizes.

It is an object of the present invention to provide the ability to hold different sockets, wrenches, and pliers.

It is an object of the present invention to provide grooves on the ends enabling them to connect together and adapt to arrangement as needed.

It is an object of the present invention to provide a unit that is embedded with magnets as a means for adding or removing widgets as is desired.

It is an object of the present invention to provide a custom tool accessory that comes with modular pieces.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side view of a custom tool accessory, in accordance with one embodiment of the present invention.

FIG. 2 illustrates a custom tool accessory, in accordance with another embodiment of the present invention.

FIG. 3 illustrates a custom tool accessory, in accordance with another embodiment of the present invention.

FIG. 4 illustrates a custom tool accessory, in accordance with another embodiment of the present invention.

FIG. 5 illustrates a custom tool accessory, in accordance with FIG. 1 of the present invention.

FIG. 6 illustrates a custom tool accessory, in accordance with FIG. 2 of the present invention.

FIG. 7 illustrates a custom tool accessory, in accordance with FIG. 3 of the present invention.

FIG. 8 illustrates a custom tool accessory, in accordance with FIG. 4 of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

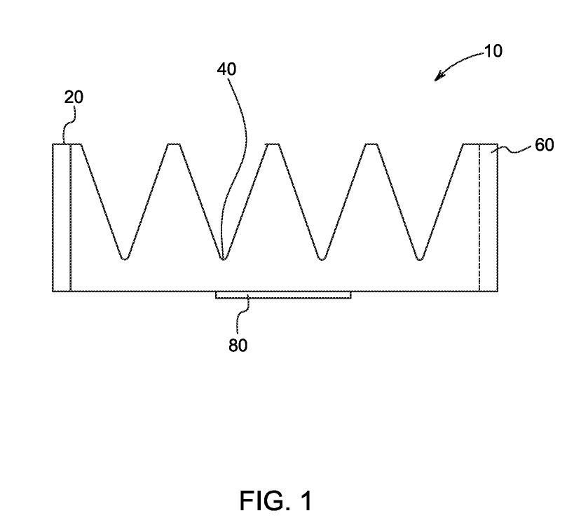

Referring now to FIG. 1, illustrated is a side view of the custom tool accessory 10, in accordance with one embodiment of the present invention.

In FIG.1, illustrated is a side view of the custom tool accessory 10, including a tongue 20, socket 40, groove to interlock units 60, and a magnet 80.

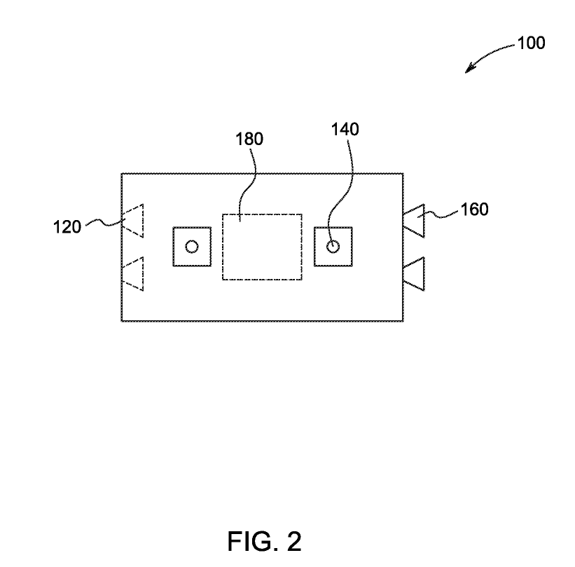

Referring now to FIG. 2, illustrated is a custom tool accessory 100, in accordance with another embodiment of the present invention.

In FIG.2, illustrated is a view of the custom tool accessory 100, including a tongue 120, socket 140, groove to interlock units 160, and a magnet 180.

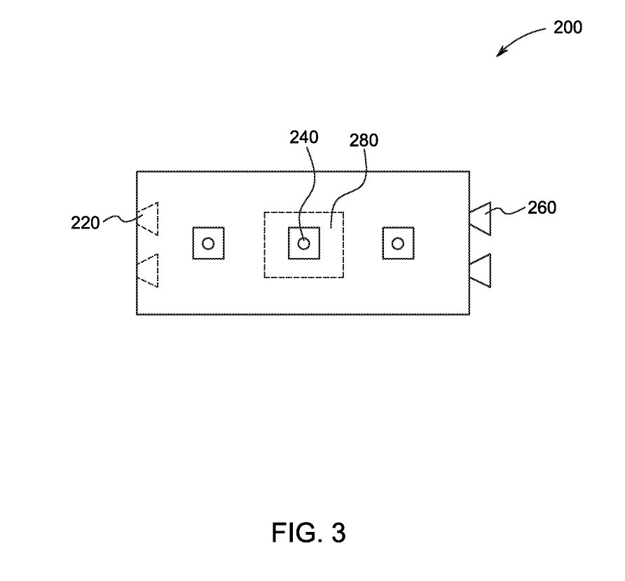

Referring now to FIG. 3, illustrated is a custom tool accessory 200, in accordance with another embodiment of the present invention.

In FIG.3, illustrated is a view of the custom tool accessory 200, including a tongue 220, socket 240, groove to interlock units 260, and a magnet 280.

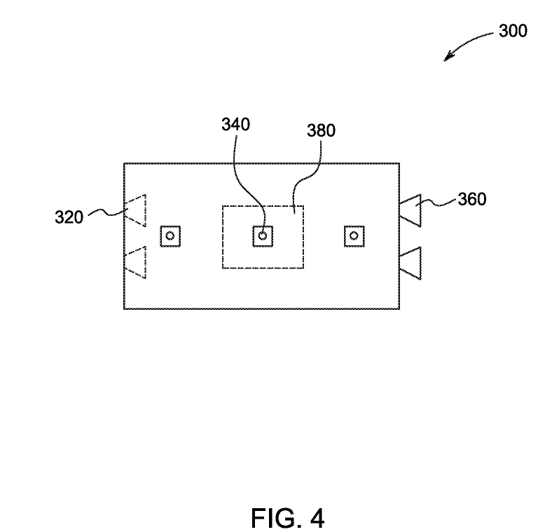

Referring now to FIG. 4, illustrated is a custom tool accessory 300, in accordance with another embodiment of the present invention.

In FIG.4, illustrated is a view of the custom tool accessory 300, including a tongue 320, socket 340, groove to interlock units 360, and a magnet 380.

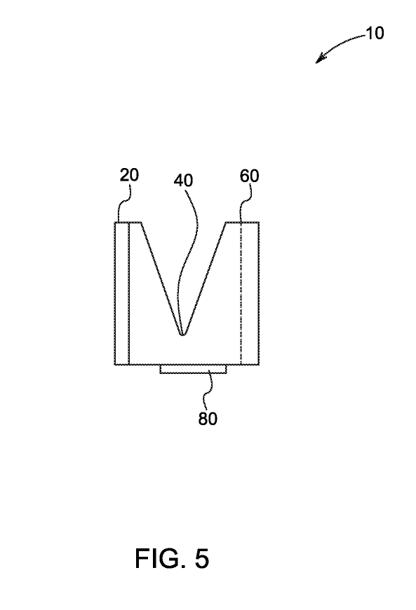

Referring now to FIG. 5, illustrated is a custom tool accessory 10, in accordance with another embodiment of the present invention.

In FIG.5, illustrated is a view of the custom tool accessory 10, including a tongue 20, socket 40, groove to interlock units 60, and a magnet 80.

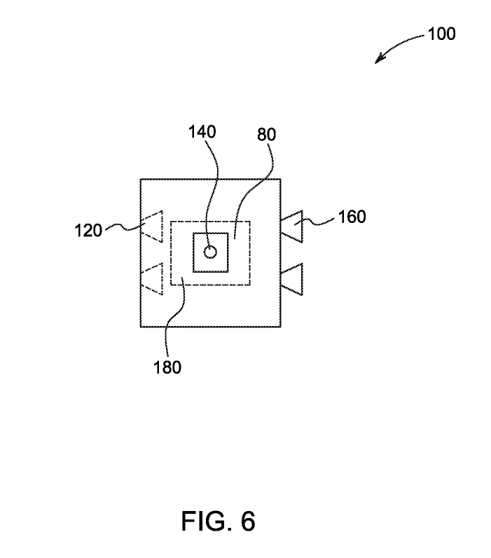

Referring now to FIG. 6, illustrated is a custom tool accessory 100, in accordance with another embodiment of the present invention.

In FIG.6, illustrated is a view of the custom tool accessory 100, including a tongue 120, socket 140, groove to interlock units 160, and a magnet 180.

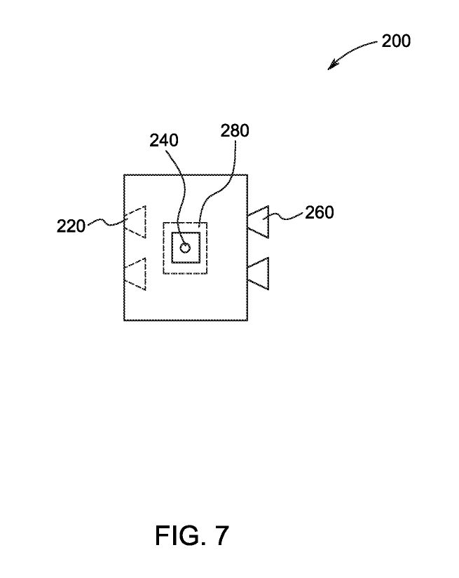

Referring now to FIG. 7, illustrated is a custom tool accessory 200, in accordance with another embodiment of the present invention.

In FIG.7, illustrated is a view of the custom tool accessory 200, including a tongue 220, socket 240, groove to interlock units 260, and a magnet 280.

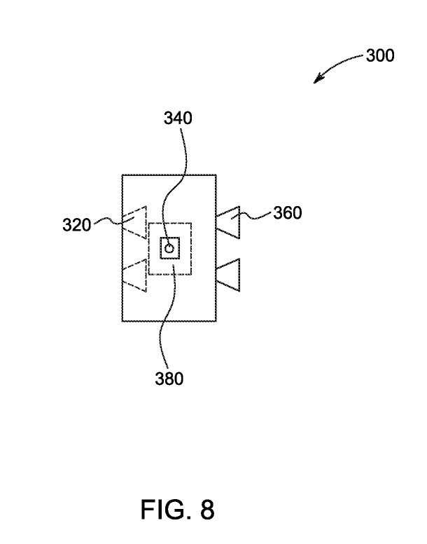

Referring now to FIG. 8, illustrated is a custom tool accessory 300, in accordance with another embodiment of the present invention.

In FIG.8, illustrated is a view of the custom tool accessory 300, including a tongue 320, socket 340, groove to interlock units 360, and a magnet 380.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A custom tool accessory, said accessory comprising:
a tongue;
grooves;
and a magnet.

2. The custom tool accessory according to claim 1, wherein said accessory comprises a widget.

3. The custom tool accessory according to claim 1, wherein said accessory is configured to fit inside a tool box.

4. The custom tool accessory according to claim 2, wherein said widget is part of a ten widget set.

5. The custom tool accessory according to claim 2, wherein said widget comes in various shapes and sizes.

6. The custom tool accessory according to claim 1, wherein said accessory is configured to hold different sockets, wrenches, and pliers.

7. The custom tool accessory according to claim 1, wherein said grooves are capable of connecting to another custom tool accessory.

8. The custom tool accessory according to claim 6, wherein said sockets are ¼, ⅜, or ½ drive sockets.

9. The custom tool accessory according to claim 1, wherein said magnet holds the accessory to a metal toolbox.
